(19) United States
(12) Patent Application Publication
(10) Pub. No.: US 2012/0171313 A1
(43) Pub. Date: Jul. 5, 2012

(54) Compositions and Methods for Applying and Manufacturing Biopesticides

(75) Inventor: Stephanie Lynn Boone, Austin, TX (US)

(73) Assignee: BOON TECHNOLOGIES, LLC., Austin, TX (US)

(21) Appl. No.: 13/335,389

(22) Filed: Dec. 22, 2011

Related U.S. Application Data
(60) Provisional application No. 61/428,741, filed on Dec. 30, 2010.

(51) Int. Cl. A01N 65/26; A01P 7/00; A01P 17/00; A01P 7/02; A01N 25/02; A01P 7/04

(52) U.S. Cl. 424/769; 514/783

(57) ABSTRACT

A pesticide composition is described herein. The invention as described herein also includes methods for controlling a pest, methods for manufacturing a pest control composition, insecticides, insect growth regulators, and compositions for interfering with a neuromodulator, neurotransmitter or neurohormone action of an insect's nervous system. The composition described has a dual “mode of action” and comprises Neem oil (that affects the Prothoracicotropic hormone, Adipokinetic hormone or Ecdysone hormone in the insects brain) along with Cedar and Aromatic essential oils (that affects the neuromodulator, neurotransmitter or neurohormone action in a pest's nervous system).

### CROSS-REFERENCE TO RELATED APPLICATIONS

This application is a non-provisional application of U.S. Provisional Patent Application No. 61/428,741 filed on Dec. 30, 2010 and entitled “Compositions and Methods for Applying and Manufacturing Biopesticides” the entire contents of which is incorporated herein by reference.

### TECHNICAL FIELD OF THE INVENTION

This application relates in general to the field of methods and compositions related to pest control.

### STATEMENT OF FEDERALLY FUNDED RESEARCH

None

### REFERENCE TO A SEQUENCE LISTING

None.

### BACKGROUND OF THE INVENTION

Without limiting the scope of the invention, its background is described in connection with pest control compositions and related methods.

U.S. Pat. No. 4,923,698 issued to Rodero (1990) is directed to a bioactive film-forming composition for control of crawling insects such as cockroaches, sewer flies, and crickets, and other crawling arthropods such as arachnids. The Rodero patent also includes a bioactive film-forming composition, which is a liquid and generally adapted to adhere to a surface, for providing an effective barrier against crawling insects and the like. Suitable insect-repellent ingredients include certain synthetic pyrethroids, N,N-diethyl-meta-toluamide, and Neem extract.

U.S. Patent Application No. 20100158828 (Ptchelintsev and Hwang, 2010) relates to compositions for topical application to the skin that comprise cis-6-nonenol and the use of such compositions to provide benefits to the skin, in particular, to provide anti-aging benefits to human skin.

U.S. Patent Application No. 20070142330 (Ansell, 2007) discloses the use of certain siloxanes and mixtures thereof in the control of arthropods such as insects and arachnids, and in particular ectoparasites, such as head lice.

### SUMMARY OF THE INVENTION

The present application includes novel pest control compositions and related methods. The application enables, describes, and claims pest control compositions comprising Neem oil, a carrier comprising a Siloxane; the masking agent may be an essential oil, or also a synthetic fragrance chemical. Non-limiting examples of essential oils include from the group consisting of Juniperus Virginiana, and Juniperus Mexicana, fractional distillations or pure oil distillations, Cedarwood oil that comprises Thujopsene, Widdrene, Widdrol, alpha-Cedrene, beta-Cedrene, Cedrol, Cuparene, Himachalene, Acoradiene, Curcumene, and Chamigrene; essential oil derived from Rosemary, Geranium, Rose, Clove, Lavender, Limonene, Orange, Cinnamon, Peppermint, Spearmint, Hyssop, Thyme, Lemongrass, Sage, Pine, Lemon, Eucalyptus, Citrus, and Citronella.

In one embodiment the instant invention discloses a pest control composition comprising: a Neem oil, wherein the Neem oil comprises Azadirachtin, Salannin, Meliantriol, and Nimbin, a carrier comprising a Siloxane and a masking agent. The masking agent used in the composition of the instant invention is an essential oil or a fragrant synthetic chemical selected from the group consisting of turpentine derivatives, natural isolates of essential oils, rare pyrazines, thiazoles, and diverse sulfur compounds.

In one aspect non-limiting examples of the essential oil or fragrant synthetic chemical include: Acetanisole Crystals, Acetate C-8, Acetate C-9, Acetate C-10, Acetate C-12 (Lauryl), Acetoin, Acetophenone Prime, Acetyl Propionyl Natural, 2-Acetyl Pyradine, 2 Acetyl Pyrazine, Agrumen Aldehyde BJ, Alcohol C-6, Alcohol C-8, Alcohol C-9, Alcohol C-10, Alcohol C-12, Aldehyde C-8, Aldehyde C-9, Aldehyde C-10, Aldehyde C-10, 50% Natural, Aldehyde C-11 Undecylenic, Aldehyde C-12 Lauric, Aldehyde C-12 MNA, Aldehyde C-14, Aldehyde C-16, Aldehyde C-17, Aldehyde C-18, Aldehyde C-20, Allo Ocimene, Allyl Amyl Glycolate, Allyl Butyrate, Allyl Caproate, Allyl Cyclo Hexyl Propionate, Allyl Heptoate, Allyl Ionone, Allyl Iso Thiocyanate, Allyl Phenoxy Acetate (Acetate PATM Type), Allyl Phenyl Acetate, Amyl Acetate Iso, Amyl Acetate Iso Natural, Amyl Acetate N, Amyl Alcohol, Iso, iso Amyl Butyrate, iso Amyl Caproate, iso Amyl Caprylate, Amyl Cinnamic Aldehyde A, Amyl Cinnamic Aldehyde Dimethyl Acetal, iso Amyl Formate, iso Amyl iso Butyrate, iso Amyl Phenyl Acetate, iso Amyl Propionate, iso Amyl Salicylate, Amyl Vinyl Carbinol, Amyris Acetate, Amyris Alcohol, Anethole Natural, Anethole Synthetic, Anisic Aldehyde, Anisyl Acetate, Aurantiol BJ, Benzaldehyde Natural, Benzaldehyde, P.G.A., Benzaldehyde, Synthetic Benzo Dihydropyrone, Benzophenone, Benzoic Acid, Benzyl Acetate, Benzyl Acetone, Benzyl Alcohol, Benzyl Benzoate, Benzyl Formate, Benzyl iso Butyrate, Benzyl iso Eugenol, Benzyl Propionate, Benzyl Salicylate, Benzylidene Acetone, Beta Carotene, Borneol Crystals, Borneol Crystals Iso, Bornyl Acetate Iso, Bornyl Acetate Laevo, iso Bornyl Cyclo Hexenol, Bornyl Propionate Iso, Bromstyrol, Butter Acids, Butter Esters, iso Butyl Acetate, iso Butyl Acetate Natural, Butyl Acetate N, Butyl Alcohol, iso Butyl Alcohol, iso Butyl Angelate, iso Butyl Benzoate, iso Butyl Butyrate, iso Butyl Caproate, iso Butyl Caproate Natural, iso Butyl Cinnamate, iso Butyl iso Valerate, iso Butyl Lactate, iso Butyl Phenyl Acetate, iso Butyl Quinolene, iso Butyl Salicylate, iso Butyl Stearate, iso Butyl-2-Methyl Butyrate, Butyl Butyryl Lactate, Butylidene Phthalate, iso Butyraldehyde, n-Butyraldehyde, Butyric Acid N, Butyric Acid N Natural, Cadinene, Camphene 46%, Camphene 94%, Camphor Gum Natural, Camphor Gum Synthetic, Capric Acid, Caproic Acid, Caprylic Acid, Caramel Furanone 100%, Carboxaldehyde (Triplal™ Type), Carvone Dextro-Carvone, Laevo-Carvacrol, Carvyl Acetate, Caryophyllene, Caryophyllene Acetate, Caryophyllene Alcohol, Cedrene, Cedrenol, Cedryl Acetate 50%, Cedryl Acetate 70%, Cedryl Acetate Crystals, Cedryl Methyl Ether, Celery Ketone, Cinnamic Acid, Cinnamic Alcohol, Cinnamic Aldehyde 92% Natural, Cinnamic Aldehyde, Cinnamyl Acetate, Cinnamyl Cinnamate, Cinnamyl iso Butyrate, Cinnamyl Propionate, Cis Jasmone, Citral 96%, Citral Natural Ex Litsea, Citral Natural Ex Lemongrass, Citronellal 85/90% ex Eucalyptus Citriodora, Citronellol Pure, Citronellol Natural, Citronellyl Acetate, Citronellyl Butyrate, Citronellyl Formate, Citronellyl Nitrile, Citronellyl Propionate, Coumarin, P-Cresol, P-Cresyl Caproate, Cuminic Aldehyde, iso Cyclo Citral, Cyclo Hexyl Acetate, Cyclo Hexyl Salicylate, Cyclo Penta Decanolide, P-Cymene, Dascenone, Damascone Alpha, Damascone Beta, Decalactone Delta, Decalactone Gamma, Delta 3 Carene, Delta Dodecalactone, Delta Nonalactone, Delta Undecalactone, Dibenzyl Ether, Dibutyl Sulfide, Diethyl Malonate, Diethyl Sebacate, Diethyl Succinate, Dihydro Anethol, Dihydro Beta Ionone, Dihydro Eugenol, Dihydro iso Jasmonate, Dihydro iso Jasmone, Dihydro Linalool, Dihydro Myrcenol, Dihydro Terpinyl Acetate, 2,6 Diiso Propyl Phenol, Dimethyl Benzyl Carbinol, Dimethyl Benzyl Carbinyl Acetate, Dimethyl Benzyl Carbinyl Butyrate, Dimethyl Benzyl Carbinyl Proprionate, Dimethyl Dioxolane, 2,6 Dimethyl-5-Heptenal (Melon Aldehyde), Dimethyl Hydroquinone, Dimethyl Hydroxy Furanone Natural, Dimethyl Octanol, Dimethyl Phenyl Ethyl Carbinol, Dimethyl Phenyl Ethyl Carbinyl Acetate, Dimethyl Resourcinol, Dimethyl Succinate, Dimethyl Sulfide, Dimethyl Sulfide Natural, Dimyrcetol, Diosphenol Natural, Dipentene P.G., Diphenyl Methane, Diphenyl Oxide, Elemol, Ethyl Acetate, Ethyl Acetate Natural, Ethyl Aceto Acetate FCC, Ethyl Amyl Ketone, Ethyl Anthranilate, Ethyl Benzoate, Ethyl Butryate, Ethyl Butyrate Natural, 2 Ethyl Butyric Acid, Ethyl Caprate (Decylate), Ethyl Caproate, Ethyl Caprylate, Ethyl Cinnamate, Ethyl Formate, 4-Ethyl Guaiacol, Ethyl Heptoate, Ethyl Iso Butyrate, Ethyl Iso Valerate, Ethyl Lactate FCC, Ethyl Laurate, Ethyl Levulinate, Ethyl Linalool, Ethyl Linalyl Acetate, Ethyl Maltol, Ethyl Myristate, Ethyl Oenanthate, Ethyl Oleate, Ethyl Oxyhydrate, Ethyl 2 Methyl Butyrate, Ethyl-2-Methyl Pentanoate (Manzanate™ Type), 2-Ethyl-3-Methyl Pyrazine, Ethyl-3-Methyl Thio Propionate, Ethyl Pelargonate, Ethyl Phenyl Acetate, Ethyl Phenyl Glycidate, Ethyl Propionate, Ethyl Propionate, Natural, Ethyl Salicylate, Ethyl Tiglate, Ethylene Brassylate, Eucalyptol, Eugenol, iso Eugenol, Eugenyl Acetate, iso Eugenyl Acetate, Farnesene, Farnesol Synthetic, Fenchone A Natural, Fenchyl Acetate, Fenchyl Alcohol Alpha, Floramelon (Helional™ Type), Gamma Hepta Lactone, Gamma Hexalactone, Gamma Methyl Ionone, Gamma Octa Lactone, Gamma Valeractone, Geraniol, Geraniol Natural ex Citronella, Geraniol Natural ex Palmarosa, Geraniol Savon, Geraniol Terpenes, Geranyl Acetate, Geranyl Butyrate, Geranyl Formate, Geranyl iso Butyrate, Geranyl iso Valerate, Geranyl Nitrile, Geranyl Phenyl Acetate, Geranyl Propionate, Geranyl Tiglate, Grapefruit Mercaptan, Guaiacol Pure, Guaiacwood Acetate, Heliotropine, Trans 2 Hexenoic Acid, Cis 3 Hexenol, Cis 3 Hexenol Natural, Cis 3 Hexenyl Acetate, Cis 3 Hexenyl Benzoate, Cis 3 Hexenyl Butyrate, Cis 3 Hexenyl Hexanoate, Cis 3 Hexenyl iso Butyrate, Cis 3 Hexenyl iso Valerate, Cis 3 Hexenyl Lactate, Cis 3 Hexenyl 2 Methyl Butyrate, Cis 3 Hexenyl Propionate, Cis 3 Hexenyl Salicylate, Hexyl Acetate FCC, A-Hexyl Cinnamic Aldehyde, Hexyl iso Valerate, Hexyl Propionate, Hexyl Salicylate, Hexyl Tiglate, Hydroxy Ambran, Hydroxycitronellal, Hydroxy Citronellal Dimethyl Acetal, Hydroxycitronellal For Soap, Hydroxycitronellal Fractions, indole Crystals, indolene, ionone Alpha 70, ionone Alpha 80, ionone Alpha-Beta, ionone Beta, ionone For Soap, ionone Terpenes, iso Amyl Iso Valerate, iso Bornyl Cyclo Hexanol, iso Cyclo Citral, iso Jasmone, iso Propyl 2-Methyl Butyrate, iso Valeraldehyde, iso Valeraldehyde Natural, iso Valerie Acid, Ketoisophorone, Lactic Acid 88%, D'Limonene, D'Limonene Redistilled, D'Limonene Sulfide, L'Limonene 75°, L'Limonene Natural, Linalool Natural ex Bois de Rose, Linalool Natural Ex Howood, Linalool Oxide, Linalool Synthetic FCC, Linalyl Acetate Natural, Linalyl Acetate Synthetic, Lyra1™, Maltol Iso Butyrate, Maltol Nautral, Maltol Synthetic, Mentho Furan, Menthol Crystals Natural Chinese, Menthol Crystals Natural Indian, Menthol Racemic, iso Menthone, Menthone Laevo, Menthone Prime, Methoxy Phenyl Butanone, 2-Methoxy 3/5/6 Methyl Pyrazine, 2-Methyl Butyraldehyde, Menthyl Acetate Laevo , Methyl Acetophenone Para, Methyl Anthranilate, Methyl Benzoate, Methyl Butyrate, 2 Methyl Butyric Acid, 2 Methyl Butyric Acid Natural, Methyl Caproate, Methyl Caprylate, Methyl Cedryl Ketone, Methyl Chavicol Ex Basil, Methyl Chavicol Ex Anise, Methyl Cinnamate, Methyl Cinnamate Natural, Methyl Cinnamic Aldhyde A, 6 Methyl Coumarin, Methyl Cyclo Myrcetone, Methyl Cyclo Pentenolone, Methyl Cyclo Pentenolone, Natural, Methyl Dihydro Jasmonate, Methyl Dioxolane, Methyl Eugenol, Methyl Heptenone, Methyl Heptine Carbonate, Methyl Heptylate, Methyl Hexyl Ketone, Methyl Ionone Alpha, Methyl Ionone BJ, Methyl Ionone Beta, Methyl Ionone for Soap, Methyl Ionone Gamma, Methyl Ionone Extra, Methyl Ionone Terpenes, Methyl iso Butyrate, Methyl iso Eugenol, Methyl-2-Methyl Butyrate, Methyl-3-Methyl Thiopropionate, Methyl-2-Nonenoate, Methyl Nonyl Ketone, Methyl Octine Carbonate, Methyl Para Cresol, Methyl Phenyl Acetate, Methyl Pomello (Methyl Pamplemousse™ Type), 2 Methyl-2-Pentenoic Acid, 2-Methyl-4-Propyl 1,3 Oxathiane, 2-Methyl Pyrazine, Methyl Salicylate, Methyl Thio Butyrate, 2-Methyl Thio Pyrazine, 2-Methyl Thio-3 (5,6) Methyl Pyrazine, Methyl Tuberal L, Milk Lactone, Mousse de Metra, Musk G 50%, Musk Ketone, Musk NY (Musk 144™ Type), Musk Xylol, Myrcene, Myrcenyl Acetate, Neofolione™, Nerol Pure, Nerolidol Synthetic, Nerolin Bromelia Crystals, Neryl Acetate Pure,2,4 Nonadienal, Nonane Diacetate (Jasmal™), Nonenal Cis-6, Nonenol Cis-6, iso Nonyl Acetate, iso Nonyl Alcohol, Nootketone, Nopol, Nopyl Acetate, 3-Octanol, 3-Octanol Natural, Octyl Acetate, Octyl iso Butyrate, Ortho Methoxy Cinnamic Aldehyde Natural, Ortho Methoxy Cinnamic Aldehyde 50%, O.T.B.C.H.A., P.T.B.C.H.A., P.T.B.C. Hexanone, Para Cresol, Para Cresyl Acetate, Para Cresyl Phenyl Acetate, Para Jasmonate, Pelargonic Acid, Perilla Aldehyde, Phellandrene Alpha, Phenoxy Ethanol (Rose Ether), Phenoxy Ethyl iso Butyrate, Phenyl Acetaldehyde, Phenyl Acetaldehyde Dimethyl Acetal, Phenyl Acetate, Phenyl Acetic Acid, Phenyl Ethyl Acetal, Phenyl Ethyl Acetate, Phenyl Ethyl Alcohol, Phenyl Ethyl Alcohol Natural, Phenyl Ethyl Benzoate, Phenyl Ethyl Butyrate, Phenyl Ethyl Cinnamate, Phenyl Ethyl Formate, Phenyl Ethyl iso Butyrate, Phenyl Ethyl iso Valerate, Phenyl Ethyl Phenyl Acetate, Phenyl Ethyl Pivilate, Phenyl Ethyl Propionate, Phenyl Ethyl Salicylate, Phenyl Ethyl-2-Methyl Butyrate, Phenyl Hexanol, Phenyl Propyl Acetate, Phenyl Propyl Alcohol, Phenyl Propyl Aldehyde, Phenyl Propyl iso Butyrate, Phenyl Salicylate, iso Phorone, Alpha Pinene P & F, Beta Pinene P & F, Piperitone, Prenol, Prenyl Acetate, Prenyl Benzoate, Prenyl Slicylate, Propenyl Guaethol, Propionic Acid, iso Propyl Acetate, N-Propyl Acetate, Propyl Alcohol, Propyl Alcohol Natural, N-Propyl Cinnamate, iso Propyl 2-Methyl Butyrate, 2-iso Propyl-4-Methyl Thiazole, iso Propyl Quinolene, Propylene Glycol, Pseudo Methyl Ionone Terpenes, iso Pulegol, Dextro Pulegone Natural, Pyridine, Pyruvic Acid, Raspberry Ketone, Raspberry Ketone, Natural, Rhodinol Ex Geranium, Rhodinol Synthetic, Rhodinyl Acetate Synthetic, Rose Crystals, Rose Oxide, Rum Ether, Sabinene, Safrole, Salicylaldehyde, Sandasweet (Sandalore® Type), Sandacanol (Bacdanal® Type), Santalex™ Type, Sclareol, Skatole, Strawberry Furanone, Strawberry Furanone 20% in PG, Styrallyl Acetate, Styrallyl Alcohol, Styrallyl Propionate, Sucrose Acetate iso Butyrate, Sugarone, Sulfurol, Tartaric Acid, Terpinen-4-01, Terpinene Alpha, Gamma Terpinene, Gamma Terpinene Natural, Alpha Terpineol, Alpha Terpineol Natural, Terpineol Perfume Grade, Terpinolene 20%, Terpinolene 90%, Terpinolene Special Rein 95%, Terpinyl Acetate, Terpinyl Acetate Natural, Terpinyl Propionate, Tetra Hydro Linalool, Tetra Hydro Linalyl Acetate, Tetra Hydro Linalyl Mufuol, Tetra Hydro Myrcenol, Theaspirin, Thiocineol 100%, Thiocineol 1% in Grapefruit Terpenes, Thiomenthone, Thymol Crystals, Thymol Crystals Natural, Thymol Natural, Para Tolyl Aldehyde, Tonalid™, Trans-4-Decen-1-Al, Trans-2-Hexenal, Trans-2-Hexenoic Acid, Trans-3-Hexenoic Acid, Trans-2-Hexenol, Trans-2-Hexenyl Acetate, Trans-2-iso Butyrate, Trans Decahydro Beta Napthyl Acetate, Triacetin FCC, Tricyclo Decenyl Acetate, Tricyclo Decenyl Propionate, Triethyl Citrate, Triethyl Citrate Natural, 3,5,5 Trimethyl Cyclo Hexenol, 3,3,5 Trimethyl Hexenal, 2,3,5 Trimethyl Pyrazine, Trimethyl Pyrazine Natural, Turpentine, Undecatriene, Undecavertol™, iso Valeraldehyde, N-Valeraldehyde, iso Valerie Acid, N-Valeric Acid, Vanillin, Ethyl Vanillin, Vanillin Iso Butyrate, Vanillin ex Eugenol, Vanillin ex Lignin, Vanillin P.G. Acetal, Veratraldehyde, Vetivert Acetate, Vetyverol, Wardia™ Replacement, Wine Fusel Oil, 2-6 Xylenol, Yara Yara Crystals, and Zingerone.

In another aspect the essential oil is selected from the group consisting of Rosemary, Geranium, Rose, Clove, Lavender, Limonene, Orange, Cinnamon, Peppermint, Spearmint, Hyssop, Thyme, Lemongrass, Sage, Pine, Lemon, Eucalyptus, Citrus, and Citronella. In yet another aspect the essential oil comprises Juniperus virginiana, Juniperus Mexicana, or both. In another aspect a wt % of the Neem oil in the composition ranges from 0.001 to 10. In a specific aspect the masking agent comprises Cedarwood oil. In another aspect the Cedarwood oil is obtained by a fractional distillation or a pure oil distillation process. In another aspect the Cedarwood oil comprises about 1% to 91% of each Thujopsene, Widdrene, Widdrol, alpha-Cedrene, beta-Cedrene, Cedrol, Cuparene, Himachalene, Acoradiene, Curcumene, and Chamigrene. In yet another aspect Siloxane is selected from the group consisting of cyclic Siloxane, linear Siloxane, Silicone, Polydimethylsiloxane, Trisiloxane, volatile Methylsiloxane, or a combination thereof. In a related aspect the Siloxane comprises 30-60% Decamethyltetrasiloxane, 30-60% Octamethyltrisiloxane, 15-40% Dodecamethylpentasiloxane, 15-40% Polydimethylsiloxane, and any combinations thereof. In one aspect a wt % of the Siloxane in the composition ranges from 25 to 98. In another aspect the composition is adapted for cosmetic application. In yet another aspect the composition is adapted for human and animal skin, hair and scalp applications.

Another embodiment of the instant invention relates to a pest control composition comprising: one or more plant derived oils and Polydimethylsiloxane. Yet another embodiment discloses a pest control pharmaceutical composition comprising: a Neem oil, a Polydimethylsiloxane, and a Trisiloxane.

In one embodiment the present invention describes a pest control composition comprising: a Cedarwood oil and a Siloxane. In one aspect the Siloxane is cyclic Siloxane, linear Siloxane, Silicone, Polydimethylsiloxane, Trisiloxane, volatile Methylsiloxane, Decamethyltetrasiloxane, Octamethyltrisiloxane, Dodecamethylpentasiloxane or a combination thereof. In another aspect the composition is adapted for cosmetic application.

Another embodiment of the present invention provides a method for manufacturing a pest control composition comprising the steps of: (i) providing a Neem oil, (ii) providing a carrier, (iii) providing a masking agent, and (iv) manufacturing the composition by suspending or dispersing the Neem oil and the masking agent in the carrier. Yet another embodiment of the present invention discloses a method for manufacturing a pest control composition comprising the steps of: providing a Cedarwood oil, providing a Siloxane, and manufacturing the composition by suspending or dispersing the Cedarwood oil with the Siloxane. Yet another method for manufacturing a pest control composition comprising the steps of: (i) using the specific gravity and temperature of each component, (ii) calculation for batch volume by percent weight are made. (iii) Where component A wt % has an optimal specific gravity between 0.04 and 1.1 at temperatures between 20° C. and 30° C. is added to the mixing container. (iv) Component B wt % has an optimal specific gravity between 0.04 and 1.1 at temperatures between 20° C. and 30° C. is added to the mixing container. (v) Where component C wt % has an optimal specific gravity between 0.04 and 1.1 at temperatures between 20° C. and 30° C. is added to the composition of A and B in the mixing container. (vi) Manual or motorized agitation to the composition is required for consistency where duration is determined by tank size, agitation method, and rate of speed. In one example, component A is silane; component B is Cedar Oil; component C is Neem Seem Oil; component D is other aromatic fragrance, oil or chemical. And the combination may include A+B, A+C, A+B+C, A+B+C+D, A+C+D and so forth.

Yet another method for manufacturing a pest control composition comprising the steps of: (i) using a metered pump or fluid measuring device (ii) calculations for each component are made in liquid volume units (iii) where each components volume is determined by mixing container capacity. (iv) Manual or motorized agitation to the composition is required for consistency where duration is determined by tank size, agitation method, and rate of speed.

In yet another embodiment the present invention relates to a method for controlling or killing one or more pests, bed bugs, insects, a pest infestation or any combinations thereof comprising the steps of: identifying a target area suspected of having the pests, bed bugs, insects, a pest infestation or any combinations thereof, treating the target area by applying an effective amount of pest control composition effective to control or kill the pests, the insects or a combination to the target area, wherein the pest control composition comprises a Neem oil, a carrier comprising Siloxane, and a masking agent comprising an essential oil comprising Cedarwood oil, and monitoring the effectiveness of the treatment by one or more methods at a regular or pre-determined time interval.

In one aspect of the method the pest control composition further comprises one or more essential oils selected from the group consisting of Rosemary, Geranium, Rose, Clove, Lavender, Limonene, Orange, Cinnamon, Peppermint, Spearmint, Hyssop, Thyme, Lemongrass, Sage, Pine, Lemon, Eucalyptus, Citrus, and Citronella. In another aspect of the method the composition is applied by spraying, fogging, or treating with aerosol. In yet another aspect of the method of the present invention the bed bugs are Cimex lectularius, Cimex hemipiterus or both. In another aspect the pest is an Arthropod selected from the group consisting of Chelicerata, and Tracheata. In a specific aspect the pest is a Myriapoda, Arachnida, or Insecta. In a related aspect the pest is a spider, ant, termite, roach, scorpion, flea, bed bug, fly, tick, lice, or mite.

The method as described hereinabove further comprises the optional steps of: (i) exposing the target area to about 30° to 33° C. for 5 days after applying the pest control composition, (ii) inspecting the target area for signs of hatched pests 5 to 10 days after applying the pest control composition, and (iii) reapplying the pest control composition if signs of hatched pests are observed. In one aspect the composition controls or kills the one or more pests, bed bugs, insects, a pest infestation or any combinations thereof by an ovicidal action, a growth regulation, an anti-feedant action, a knockdown, a contact kill, a repellent action, or any combinations thereof.

In another embodiment the present method provides a method for controlling one or more pests, bed bugs, insects, a pest infestation or any combinations thereof in a target area comprising: (i) identifying a target area suspected of having the pests, bed bugs, insects, a pest infestation or any combinations thereof, (ii) treating the target area by applying an effective amount of pest control composition effective to control or kill the pests, the insects or a combination to the target area, wherein the pest control composition comprises a Cedarwood oil and a Siloxane, and (iii) monitoring the effectiveness of the treatment by one or more methods at a regular or pre-determined time interval. In one aspect the pest control composition further comprises one or more essential oils selected from the group consisting of Rosemary, Geranium, Rose, Clove, Lavender, Limonene, Orange, Cinnamon, Peppermint, Spearmint, Hyssop, Thyme, Lemongrass, Sage, Pine, Lemon, Eucalyptus, Citrus, and Citronella. In another aspect the composition is applied by spraying, fogging, or treating with aerosol. In a specific aspect the bed bugs are Cimex lectularius, Cimex hemipiterus or both. In yet another aspect the pest is an Arthropod selected from the group consisting of Chelicerata, and Tracheata. In another aspect the pest is a Myriapoda, Arachnida, or Insecta. In another aspect the pest is a spider, ant, termite, roach, scorpion, flea, bed bug, fly, tick, lice, or mite.

The pest control method described above further comprises the optional steps of: (i) exposing the target area to about 30° to 33° C. for 5 days after applying the pest control composition, (ii) inspecting the target area for signs of hatched pests 5 to 10 days after applying the pest control composition, and (iii) reapplying the pest control composition if signs of hatched pests are observed. In another aspect the composition controls or kills the one or more pests, bed bugs, insects, a pest infestation or any combinations thereof by an ovicidal action, a growth regulation, an anti-feedant action, a knockdown, a contact kill, a repellent action, or any combinations thereof.

In one embodiment the instant invention discloses an insecticide composition comprising Cedarwood oil and Siloxane. Another embodiment of the instant invention relates to a method for controlling one or more pests comprising the steps of: applying an amount of pest control composition effective to control pests to a target area wherein the pest control composition comprises a Neem oil, wherein the Neem oil comprises between 3000 and 10000 ppm Azadirachtin, Salannin, Meliantriol, and Nimbin, a masking agent selected from the group consisting of a carrier comprising Siloxane, and an essential oil. In a specific aspect the essential oil is Cedarwood oil. For example, in one specific aspect the Azadirachtin is 3000 ppm.

In yet another embodiment the present invention discloses a pest control composition comprising: a Neem oil, wherein the Neem oil comprises between 3000 and 10000 ppm Azadirachtin, Salannin, Meliantriol, and Nimbin, at least one essential oil, and a carrier comprising about 25 to 98% of the composition. In one aspect the carrier comprises 30-60% Decamethyltetrasiloxane, 30-60% Octamethyltrisiloxane, 15-40% Dodecamethylpentasiloxane, 15-40% Polydimethylsiloxane, and any combinations thereof. In a specific aspect the essential oil is Cedarwood oil. For example, in one specific aspect the Azadirachtin is 3000 ppm.

One embodiment of the instant invention relates to an insect growth regulator composition for inhibiting the production, action, &/or function of Prothoracicotropic hormone, Adipokinetic hormone, Ecdysone hormone, and Chitin synthesis comprising: Neem oil, an essential oil selected from the group consisting of Cedarwood Oil, Rosemary, Geranium, Rose, Clove, Lavender, Limonene, Orange, Cinnamon, Peppermint, Spearmint, Hyssop, Thyme, Lemongrass, Sage, Pine, Lemon, Eucalyptus, Citrus, and Citronella, and an agent comprising a carrier, a surfactant, an emulsifier or an adjuvant. In one aspect the composition further comprises a Siloxane. In a related aspect the essential oil affects a neuromodulator, a neurotransmitter or a hormone action in a pest's nervous system. Another embodiment of the instant invention relates to an insect growth regulator inhibiting the production, action, &/or function of Prothoracicotropic hormone, Adipokinetic hormone, Ecdysone hormone action, and Chitin Synthesis inhibition comprising: a Neem oil; a Siloxane; and an essential oil comprising Cedarwood oil. In a related aspect the insect growth regulator affects a neuromodulator, a neurotransmitter or a hormone action in a pest's nervous system.

Yet another embodiment of the instant invention relates to a composition for interfering with a neuromodulator, neurotransmitter, or neurohormone action of an insect nervous system comprising: an octopamine, and a tyramine. Another embodiment of the present invention provides a method for interfering with a neuromodulator, neurotransmitter or neurohormone action in a pest's nervous system comprising the steps of: applying a composition comprising an octopamine interruption agent and a biological precursor tyramine by contacting the pest with the composition or by spraying, fogging, or treating with aerosol a target area comprising the pests and monitoring a modulation or a change in the pest's physiological and behavioral processes to determine an effectiveness of the interference in the neuromodulator, neurotransmitter, or neurohormone action in the pests nervous system.

### BRIEF DESCRIPTION OF THE DRAWINGS

None.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The phrase “controlling a pest” as used in the present invention includes killing of the pest or its offspring; killing of larval stages of the pest, killing of the pest's eggs, starving the pest, suffocating the pest, inhibiting fertility of the pest, reducing fertility of the pest, reducing the number of the pests present at the target site, inducing or forcing the pests to leave the target site, preventing settlement of the pest at the target site, rendering the pest inactive, or knockdown of the pest; it includes ovicidal action, effecting growth regulation, anti-feedant action, contact kill, repellent action; neuromodulator, neurotransmitter, or neurohormone action.

As used herein, the phrase “pest control composition” is intended to encompass pest repellents, insecticides, larvacides, ovicides, growth regulators, anti-feedant, knock-down agent and the like. The term “effective amount” regarding a composition to control pest refers to that dosage of active substance sufficient to exert the desired activity.

A pest is an animal that is detrimental to humans or human affairs, or that annoys a person. Pests include all insects and spiders. The term “pest” includes organisms belonging to Arthropods, in particular Chelicerata, Tracheata, but not Crustacea. In particular embodiments, pests include Myriapoda, Arachnida, or Insecta. In certain embodiments, the pest is a bed bug, flea, roach, or ant. In a preferred embodiment, pests are ectoparasites such as fleas, bed bugs, flies, ticks, lice, or mites. In another preferred embodiment, the pest is Cimex lectularius or Cimex hemipterus.

Essential oils are volatile oils and natural products. Essential oils have been known for centuries in many cases and even millennia, and this term is well known in the art. Essential oils are available commercially. An oil is “essential” in the sense that it carries a distinctive odor, scent, or essence, of the plant; therefore, essential oils convey characteristic fragrances. A botanical source is odorous if an odor can be detected by any animal, or pest not just a human; “odorous” thus is simply an indication that some volatile component is present in the plant. Because of their hydrophobic nature, essential oils are not readily miscible in water. The phrase “essential oil” as used herein does not include neem oil.

A number of essential oils are recognized by the Code of Federal Regulations, Title 21, as GRAS (generally recognized as safe) compositions that do not require regulatory agency approval. See particularly parts 182.10, 182.20, 182.40, 182.50, and 182.60 of 21 CFR. Additional essential oils and components of essential oils are identified in 21 CFR 172.510 and 172.515 as having been used previously in foods, although they are not on the GRAS list. A number of important essential oils are set out below, although the invention is not limited to the specific essential oils (and components) listed individually in the specification. Suitable essential oils for use in particular compositions include, for example, Abies Sibirica Oil, Amyris Balsamifera Oil, Anise (Illicium verum) Oil, Balm Mint (Melissa officinalis) Oil, Basil (Ocimum basilicum) Oil, Bay (Pimenta acris) Oil, Bee Balm (Monarda didyma) Oil, Bergamot (Citrus aurantium bergamia) Oil, Birch (Betula aba) Oil, Bitter Orange (Citrus aurantium amara) Oil, Cabbage Rose (Rosa centifolia) Oil, Calendula Officinalis Oil, California Nutmeg (Torreya californica) Oil, Camellia Sinensis Oil, Capsicum Frutescers Oleoresin, Caraway (Carum carvi) Oil, Cardamon (Elettaria cardamomum) Oil, Cedarwood (Cedrus atlantica) Oil, Chamaecyparis Obtusa Oil, Chamomile (Anthemis nobilis) Oil, Cinnamon (Cinnamomum cassia) Oil, Citronella (Cymbopogon nardus) Oil, Clary (Salvia sclarea) Oil, Clove (Eugenia caryophyllus) Oil, Cloveleaf (Eugenia caryophyllus) Oil, Coriander (Coriandrum sativum) Oil, Coriander Seed Oil, Cyperus Esculentus Oil, Cypress (Cupressus sempervirens) Oil, Eucalyptus Citriodora Oil, Eucalyptus Globulus Oil, Fennel (Foeniculum vulgare) Oil, Gardenia Florida Oil, Geranium Maculatum Oil, Ginger (Zingiber officinale) Oil, Gold of Pleasure (Camelina sativa) Oil, Grapefruit (Citrus grandis) Oil, Hops (Humulus lupulus) Oil, Hypericum Perforatum Oil, Hyptis Suaveolens Oil, Indigo Bush (Dalea spinosa) Oil, Jasmine (Jasminum officinale) Oil, Juniperus Communis Oil, Juniperus Virginiana Oil, Labdanum (Cistus labdaniferus) Oil, Laurel (Laurus nobilis) Oil, Lavandin (Lavandula hybrida) Oil, Lavender (Lavandula angustifolia) Oil, Lemon (Citrus Medica Limonum) Oil, Lemongrass (Cymbopogon schoenanthus) Oil, Leptospermum Scoparium Oil, Lime (Citrus aurantifolia) Oil, Linden (Tilia cordata) Oil, Litsea Cubeba Oil, Lovage (Levisticum officinale) Oil, Mandarin Orange (Citrus nobilis) Oil, Massoy Bark Oil, Matricaria (Chamomilla Recutita) Oil, Moroccan Chamomile Oil, Musk Rose (Rosa moschata) Oil, Myrrh (Commiphora myrrha) Oil, Myrtle (Myrtus communis) Oil, Norway Spruce (Picea excelsa) Oil, Nutmeg (Myristica fragrans) Oil, Olax Dissitiflora Oil, Olibanum, Opoponax Oil, Orange (Citrus aurantium dulcis) Flower Oil, Orange Oil, Palmarosa (Cymbopogon martini) Oil, Parsley (Carom petroselinum) Seed Oil, Passionflower (Passiflora incarnate) Oil, Patchouli (Pogcstemon cablin) Oil, Pelargonium Graveolens Oil, Pennyroyal (Mentha pulegium) Oil, Peppermint (Mentha piperita) Oil, Pine (Pinus palustris) Oil, Pine Tar Oil, Pine (Pinus pinea) Kernel Oil, Pine (Pinus pumiho) Oil, Pine (Pinus sylvestris) Cone Oil, Rosemary (Rosmarinus officinalis) Oil, Rose Oil, Rosewood (Aniba rosseodora) Oil, Rue (Ruts graveolens) Oil, Sage (Salvia officinalis) Oil, Sambucus Nigra Oil, Sandalwood (Santalum album) Oil, Sandarac (Callitris quadrivalvis) Gum, Sassafras Officinale Oil, Sisymbrium Ino Oil, Spearmint (Mentha viridis) Oil, Sweet Marjoram (Origanum majorana) Oil, Sweet Violet (Viola odorata) Oil, Tar Oil, Thuja Occidentalis Oil, Thyme (Thymus vulgaris) Oil, Vetiveria Zizanoides Oil, Wild Mint (Mentha arvensis) Oil, Ximenia Americana Oil, Yarrow (Achillea millefolium) Oil, Ylang Yang (Cananga odorata) Oil, or any combinations thereof.

In some embodiments, an essential oil is a predominately volatile material or materials isolated by some physical (as opposed to chemical) process from an odorous, single-species, botanical source. The oils extracted by the physical process can contain some non-volatile material. A most widely used process for the isolation of essential oils is steam distillation of plant matter, although dry distillation, supercritical fluid extraction, and solvent extraction are also used.

The term “masking agent” as used herein refers to a component of a composition. One purpose of the masking agent is hiding or masking the presence of other compounds of the composition; in addition, in embodiments, the masking agent together with other compounds of the composition increases the effect of controlling the pest beyond what would be expected by a mere combination of the compounds. In one embodiment, the masking agent comprises an essential oil. The masking agent as used herein does not include neem oil.

In particular embodiments, the masking agent is selected from a number of synthetic fragrances or other odor masking compounds. In this regard, the phrase “Synthetic fragrance chemical” refers to synthetic, or man-made, chemicals. Chemists have succeeded in analyzing the essential oils from which natural perfumes are made and in creating thousands of synthetic fragrances, some simulating natural products and others yielding altogether new fragrances. Non-limiting examples of synthetic fragrance chemicals are Bergamot 37 and 430, Geranium 76 and Pomeransol 314, and Powder Mask CE-32907. In particular embodiments, suitable synthetic fragrances include those compiled by the US Food and Drug Administration in Title 21 of the Code of Federal Regulations, Sections 172.510 and 172.515 respectively.

The terms “Siloxane” as used herein refers to all compounds that have at least one R₂SiO unit. R may be a monovalent organic radical (for example, methyl or phenyl), and the terminating groups may be a trimethylsiloxy groups. In particular embodiments, Siloxane may be homopolymers and copolymers. The siloxane polymer may be branched or linear. Particular embodiments of the present application employ a carrier that may comprise a Siloxane, Silicone,

PDMS, VMS, or cyclic or straight chain. In particular cosmetic embodiments, Siloxane comprises Dimethicone, or Trisiloxane. Because plant derived oils break down quickly in the presence of water, heat, and UV rays, Siloxanes are used in many industries to protect from UV rays and heat, acting as an insulator. When combined, the siloxanes protect and extend the life of the bio-based actives, such as Neem oil or masking agent. In certain embodiments, the siloxane is quick drying and leaves Neem to act as repellent, Residual insect growth regulator and also as anti-feedant.

In a preferred embodiment, Siloxane comprises 30.0-60.0 wt% Decamethyltetrasiloxane (CAS No.141-62-8); 30.0-60.0 wt % Octamethyltrisiloxane (CAS No. 107-51-7); 15.0-40.0 wt % Dodecamethylpentasiloxane (CAS No. 141-63-9); and 15.0-40.0 wt % Polydimethylsiloxane (CAS No. 63148-62-9). Siloxanes, silicones are commercially available from Xiameter, Dow, Nexeo and Ashland Chemical. In further embodiments, Siloxane includes cyclic Siloxane, linear Siloxane, Silicone, Polydimethylsiloxane, Trisiloxane, volatile Methylsiloxane, Decamethyltetrasiloxane, Octamethyltrisiloxane, or Dodecamethylpentasiloxane.

Neem (Azadirachtin indica), is a tropical evergreen tree. Neem oil is derived from the fruits and seeds of a neem tree. Neem oil as employed in the present application is cold pressed Neem oil, containing 3000 ppm Azadarachtin primary, salinnin, meliantriol, and nimbinand is obtained by Plasma Power Private Limited Chennai, India.

Neem oil of the present application contributes to the multiple possible modes of action, such as repellent, insect growth regulator, anti-feedant, ovicidal, ovi-position deterrent, or by interference with the molting process, by interrupting hormonal action of Prothoracicotropic hormone, ecdysone, Adipokinetic hormone, or Diacylglyerols. Neem oil is regarded as GRAS or nontoxic to mammals, to the environment, and UV or heat promotes its degradation. Neem oil and derivatives contributes to controlling pests including insects, mites, ticks, and nematodes also by affecting the pest's behavior and physiology. Neem does not normally kill pests right away but repels pests and affects the pest's growth. In contrast, Neem products are non-toxic to higher animals and most beneficial insects.

In certain embodiments, the compositions are prepared by mixing Neem oil and masking agent with the carrier. A commercial mixer, blender, or homogenizer may be used to mix the individual components of the composition.

In a preferred embodiment, the composition is prepared by stirring, shaking, blending, tumbling, vibrating or agitating. Each component of the composition is added to a mixing tank according to the desired formulation, followed by agitation between 2 minutes and 2 hours, until all components are blended and the individual components or precipitates are no longer visible to the naked eye.

In a further embodiment, the composition is prepared by increasing the temperature of the individual components to about 50° C. before mixing. After mixing, the components are dissolved and merged into a composition by agitation. The composition is cooled to room temperature once all components have blended.

In a further embodiment, the composition is prepared by employing a sonicator and applying ultrasonic sound waves while agitating the mixture until all components have merged.

In certain embodiments, the carrier used to prepare the composition may be a dispersible solid carrier at room temperature.

In some embodiments, the composition is blended employing a commercial bead mill, rod mill, or ball mill.

In another preferred embodiment, carrier vehicle assistants, e.g., surface-active agents, including emulsifying agents and/or dispersing agents, are added during mixing.

In yet another embodiment, water is added in order to dilute the composition, and organic solvents may be added as auxiliary solvents in a preferred embodiment.

In preferred embodiments, the compositions as prepared do not require further agitation before application (the composition is not a “shake-well” product). In this embodiment, the composition does not separate out and does not require thorough shaking before mixing. Such compositions are prepared in a single step procedure, wherein the one or more essential oils act as solvent and are able to, e.g., solubilize Neem oil. In contrast, other products require thorough shaking or agitation before application in order to disperse components that have separated or precipitated during storage.

In a preferred embodiment, Neem oil is employed, and use of the composition within 8 hours to 24 hours is not absolutely required (as it is required for other products in which Neem oil degrades or breaks down over time upon exposure to e.g., water, UV-light, or heat). In such embodiments, Neem oil is blended with essential oils.

In certain embodiments, the components of the composition for delivering a lethal dose of composition to a target area or for providing multiple modes of action against insect life cycle as residual are combined into a suspension. The composition of the present invention has an anticipated shelf life of 2 to 3 years and once applied is effective up to 14 days and in some cases for over 30 days. In a preferred embodiment, the composition is designed to be light-weight and is a non-staining solution.

The proportion of masking agent in the composition is determined by the strength of the particular fragrance to be used may be up to 60% of the weight of the composition. In a preferred embodiment, the proportion of fragrance is 0.002-25% by weight of the composition. The essential oil employed in the present invention may be distilled or extracted from plants or may also be produced by solvent extraction.

Further embodiments of compositions comprise essential oils of sources of essential oils are Rosemary, Geranium, Rose, Clove, Lavender, Limonene, Orange, Cinnamon, Peppermint, Spearmint, Hyssop, Thyme, Lemongrass, Sage, Pine, Lemon, Eucalyptus, Citrus, Citronella, or any combinations thereof. In a particular embodiment, the essential oil is cedarwood oil. The term “cedarwood oil” may generally refer to volatile whole oil extracts derived principally from the heartwood of Juniperus virginiana, Juniperus mexicana, or Juniperus ashei. Cedarwood oil is a known repellent, but its action to kill or knockdown was not known.

In a particular embodiment, constituents of the whole oil cedarwood extract include thujopsene, cedrol, alpha-copaene, alpha-cedrene, beta-cedrene and widdrol. In a preferred embodiment, cedar wood oil comprises Thujopsene, Widdrene, Widdrol, alpha-Cedrene, beta-Cedrene, Cedrol, Cuparene, Himachalene, Acoradiene, Curcumene, and Chamigrene. In a particular embodiment, Texas cedarwood oil, a material having a high thujopsene content, otherwise properly known as Juniperus mexicana, is employed. Juniperus mexicana grows abundantly in the southwestern parts of Texas, toward the south in Mexico and Central America.

The cedarwood oil (CAS No. 8000-27-9) is generally steam distilled from the heartwood of this tree which is filled substantially exclusively for the purpose of producing the essential oil. The crude oil is a viscous liquid having an odor, which is pleasant, sweet woody yet somewhat tar-like or cade-like and smoky.

in a preferred embodiment, the Cedarwood oil comprises steam-distilled fractions of Juniperus virginiana, or Juniperus Mexicana, which may be obtained from Texarome (Leakey, Tex.) or Polarome (Jersey City, N.J.). In other preferred embodiments, cedarwood oil employed was produced by fractional distillations or pure oil distillations.

Octopamine (β,4-dihydroxyphenethylamine), as used herein, is an endogenous biogenic amine. The biogenic amine octopamine plays a role as a transmitter, hormone, and neuromodulator in invertebrates (see P. D. Evans, Adv. Insect Physiol. 15:317-473 (1980)). Through the use of pharmacological and biochemical assays, specific receptors for octopamine have been identified in many invertebrate phyla, including arthropods and mollusks (J. A. Nathanson and P. Greengard, Science. 180:308-310 (1973)).

Before application, a target area suspected of having the pest is identified. Identification includes visual inspection for signs of past, present, or likely future pest activity. Identifying a target area may also be performed by evaluating information obtained derived from the target area. The “target area” includes the area likely to be contacted by the pest after application of the composition. One or more chemical signatures that indicate pest activity may be employed to identify the target area. Target area may include structural features; premises; residential, commercial, agricultural or industrial estates; agricultural farm animals for food consumption; poultry; domestic animals; exotic animals; wild animals; factories; and humans.

In another embodiments trapping, use of animals such as a canines, interrogation of a person with knowledge of the target area, surveillance, electronic surveillance, or chemical surveillance is used to identify the target area.

The composition may be applied by any pesticide application method commonly employed by one skilled in the art, or equivalents even developed later. In a preferred embodiment, the composition of the present application may be applied as aerosol, with a compression sprayer, atomizer, tank spray, or as fog. In a preferred embodiment, humidly sized droplets (of particle sizes ranging from 0.001 microns to 200 microns) containing the composition are generated using an atomizer or fogger; this embodiment is especially preferred where the pest is a flea, tick, bed bug, mite, or any other common household and public health pest infestation.

In a particular embodiment, the composition is reapplied as necessary without any harmful effects. The timing of reapplication depends on the pest, pre and post pest pressure, environmental factors like ambient temperature and humidity at the target area. Generally, a follow up visit is made, followed by reapplication of the composition every 30 days to 3 months for routine or preventive maintenance and pest control. If the infestation is heavy, further inspection and treatments may be needed.

If after spraying or fogging the composition of the present invention, the temperature of the target area is adjusted to 30° to 33° C.; then, about 5 days later, the target area is inspected and the composition is reapplied if any hatching of pests or pest activity is observed. No other treatment method is needed; however, vacuuming for cleaning dead pests or washing of clothes to remove pests may optionally be performed. Generally it is not needed to bag the target area, e.g., encase a mattress.

In particular embodiments for cosmetic purposes, the composition comprises PDMS/VMS. This embodiment has also improved penetration and insulation abilities compared to water based traditional pesticides; it is regarded as GRAS (generally recognized as safe); non-toxic to mammals or environment; does not bioaccumulate, and breaks down in 10-30 days in environment. In a preferred embodiment of a cosmetic composition, the siloxane is a non-volatile or a cyclic siloxane. Embodiments of the present application provide significant advantage over vacuuming alone or with or without an insecticide or combination of insecticides and insect growth regulators when treating pests as bed bugs within crevices can hold on against the suction forces and the insecticides cannot reach them. The eggs themselves are glued in place when laid and resist removal via vacuum; therefore, other control measures must be applied subsequently. In addition, disposal of vacuum bag or bag-less debris can spread pests such as bed bugs, nymphs, or eggs to other locations. Therefore, all target sites need to be treated with the composition even if vacuumed before.

Embodiments of the present application also provide a significant advantage over heat treatment, e.g., the use of steam. Steam is able to kill all bed bug stages including the eggs. Because most insecticides have no ovicidal activity, insecticides must be combined with steam treatment. A study by (Meek 2003) has shown that a program that employs steam followed by insecticides provides better long-term control than with the use of insecticides alone. The Meek study was the only study with steam as a variable and was not peer-reviewed, but the observed results were promising. PMPs treated one hotel with conventional techniques using dust material under the carpet at the floor/wall junction and in the wall voids. PMPs treated the mattresses per the pesticide label directions with a liquid residual and encased them. PMPs treated the second hotel with residual dust materials in the same fashion as the first, but they treated the mattress and box spring with steam instead of pesticide. The PMP monitored for recurrences. In both hotels, the bed bug population crashed after 60 days. Within 90 days, the company received callbacks from the first hotel. The second hotel remained controlled for the duration of the monitored time (12-plus months). However, pest control cannot reliably be achieved with steam alone or insecticides alone. Steam flow rate must be kept to a minimum to avoid blowing bed bugs about (along with exuviae which may contain eggs and nymphs). The present application does not require steam treatment because the composition is able to kill eggs. In addition, neem oil used herein breaks down at temperatures above 40° C., but heat for washing and drying (min 30 min) clothes must reach 60° C., and steam temperature must reach 70° to 80° C.

Similarly, commercially available and known insect growth regulators do not kill on contact, and cannot penetrate porous or non-porous materials sufficiently. Likewise, insecticides registered for bed bug control have little proven ovicidal activity and, thus, do not kill the eggs. These products also provide insufficient residual control and thus do not kill newly emerged nymphs. In addition, insecticides such as permethrin or pyrethroid are no longer sufficiently effective as insects have become resistant. Often, the use of synthetic chemicals, extreme heat, and extreme cold, requires businesses, hotels, housing authorities, or hospitals to be shut down for 5 hours to several days or even weeks , but the present application provides methods that do not necessitate such measures. In contrast only minimal downtime is required as a consequence of superior penetration, contact kill with low to no toxicity to humans, residual insect growth regulation, and other modes of activity for controlling pests.

Application of the composition of the present invention results in both a knockdown and residual kill of pests with low to no toxic effect to humans, animals, or environment. One benefit of the present application is a cost-effective alternative to synthetic chemicals, heat, cold, tenting, etc. Raising the temperature after applying the composition alone or in combination with another causes pest that remained in cracks or crevices during application out; it forces hatching; and causes deformation, because of, e.g., insect growth regulator action. Pests are therefore not able to feed or reproduce, or never hatch.

When the composition is applied so that direct contact with the pest occurs, the pest cannot survive; such contact kill composition provides fast knockdown. In addition, residual insect growth regulator activity or anti-feedant activity causes the termination of a pest's life cycle. In the absence of direct contact, beneficial insects are not harmed, because beneficial insects are sight driven to food, water, and reproductive mates, and not pheromone or hormone driven, no adverse effects occur.

Knockdown with 100% morbidity occurs within 0.05 seconds to 5 minutes. Insect growth regulator activity is present up to14 days (in some cases >30 days) after application; this prevents a pest in its larval stage to grow into fertile adult pests. Anti-feedant activity is present up to 14 days (in some cases >30 days). One residual effect of neem oil is that the insects that were not directly sprayed will not eat and, therefore, are not able to live or reproduce. Repellent activity is present up to 14 days (in some cases >30 days), so is ovicidal, antifungal, antiviral, pesticidal, insecticidal activity.

The composition of the present application is able to kill eggs of pests (is ovicidal) and the need for multiple control measures (vacuum, pesticide, steam/heat, cold) is eliminated. All furniture, floors, carpet, mattress, bedding, drawers, linens, clothes, etc. can be sprayed, fogged, or contacted with composition.

In a preferred embodiment, the composition has an increased flow rate (composition is not very thick); this is accomplished by employing low molecular weight components. Such composition provides superb penetration into cracks, crevices, or fibrous materials. The methods of the present application do not require techniques that might lead to a blowing away of bed bugs or exuvaie.

When the composition of the present application is applied with direct spray or fog, even if the bed bugs are not contacted, the insect growth regulator activity, anti-feedant activity, ovi-repellent activity, hormone interruption will cause the following: 1) eggs will not hatch or will hatch with deformities and can not function, eat, or reproduce; 2) adults will not be able to take a blood meal (eat) and will eventually starve; 3) adults will not be able to produce offspring, eliminating the next generation or life cycle; and/or 4) eggs or nymphs that were not directly contacted may hatch or molt within 1 to 14 days but will not take a blood meal or reproduce once it comes into contact with the residual composition.

The following examples describe the various studies and results obtained using the composition of the present invention.

### EXAMPLE I

### Composition Comprising Cedarwood Oil and Siloxane

The composition cause 100% knockdown and mortality of adult bed bugs and fleas within 28 seconds and 39 seconds, respectively, using between 5 grams and 35 grams of composition per 30 square inches-ICR LAB 2009.

### EXAMPLE II

### Composition Comprising Neem Oil, Cedarwood Oil at Various Percentages and Siloxane

The composition cause 100% knockdown and mortality of adult bed bugs and fleas within 30 seconds to 2 minutes, using between 2.5 grams and 4 grams of solution per 30 square inches-ICR LAB 2010

The composition was tested on adults and eggs. The direct spray composition caused immediate immobilization of the bed bug nymphs, followed by 100% mortality within 1 minute of the topical application. In addition to being 100% effective on bugs directly treated with the product, it also proved to be effective against eggs that were directly treated. None of the 61 treated eggs hatched after 17 days compared to 75% egg hatch in a non-treated control-Rutgers University groups (2009).

### EXAMPLE III

### Composition Comprising Cedarwood Oil and Siloxane

The results obtained for compositions comprising cedarwood oil in combination with siloxane were compared with the individual components of cedarwood oil and siloxane alone. The results indicated that the individual components alone had little to no effect; in contrast, the combining the components was highly effective. Direct spray caused immediate immobilization of the bed bug nymphs, followed by 100% mortality within 1 minute of the topical application. In addition, to being 100% effective on bugs directly treated with the product, the combined composition was also effective against eggs that were directly treated. None of the 61 treated eggs hatched after 17 days compared to 75% egg hatch in a non-treated control groups.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

U.S. Pat. No. 4,923,698: Bioactive Film-Forming Composition for Control of Crawling Insects and the Like.

U.S. Patent Application No. 20100158828: Topical Compositions containing CIS-6-Nonenol and its Derivatives and Methods for Treating Skin.

U.S. Patent Application No. 20070142330: Method and Composition for the Control of Arthropods.

Meek, F. (2003) Bed bugs bite back. Pest Control Technology. 31(7): 43, 44, 46, 47, 50, And 52.

1. A pest control composition comprising:
a Neem oil, wherein a wt % of the Neem oil in the composition ranges from 0.001 to 10 and the Neem oil comprises Azadirachtin, Salannin, Meliantriol, and Nimbin;
a carrier comprising a Siloxane, wherein a wt % of the Siloxane in the composition ranges from 25 to 98; and
a masking agent.

2. The composition of claim 1, wherein the masking agent is an essential oil or a fragrant synthetic chemical selected from the group consisting of turpentine derivatives, natural isolates of essential oils, rare pyrazines, thiazoles, and diverse sulfur compounds.

3. The composition of claim 2, wherein the essential oil is selected from the group consisting of Rosemary, Geranium, Rose, Clove, Lavender, Limonene, Orange, Cinnamon, Peppermint, Spearmint, Hyssop, Thyme, Lemongrass, Sage, Pine, Lemon, Eucalyptus, Citrus, and Citronella.

4. The composition of claim 2, wherein the essential comprises Juniperus virginiana, Juniperus Mexicana or both.

5. The composition of claim 1, wherein the masking agent comprises Cedarwood oil.

6. The composition of claim 6, wherein the Cedarwood oil comprises about 1% to 91% of each Thujopsene, Widdrene, Widdrol, alpha-Cedrene, beta-Cedrene, Cedrol, Cuparene, Himachalene, Acoradiene, Curcumene, and Chamigrene.

7. The composition of claim 1, wherein the Siloxane is selected from the group consisting of cyclic Siloxane, linear Siloxane, Silicone, Polydimethylsiloxane, Trisiloxane, volatile Methylsiloxane or a combination thereof.

8. The composition of claim 1, wherein the Siloxane comprises 30-60% Decamethyltetrasiloxane, 30-60% Octamethyltrisiloxane, 15-40% Dodecamethylpentasiloxane, 15-40% Polydimethylsiloxane, and any combinations thereof.

9. A method for controlling or killing one or more pests, bed bugs, insects, a pest infestation or any combinations thereof comprising the steps of:
identifying a target area suspected of having the pests, bed bugs, insects, a pest infestation or any combinations thereof;
treating the target area by applying an effective amount of pest control composition effective to control or kill the pests, the insects or a combination to the target area, wherein the pest control composition comprises a Neem oil, a carrier comprising Siloxane, and a masking agent comprising an essential oil comprising Cedarwood oil; and
monitoring the effectiveness of the treatment by one or more methods at a regular or pre-determined time interval.

10. The method of claim 9, wherein the pest control composition further comprises one or more essential oils selected from the group consisting of Rosemary, Geranium, Rose, Clove, Lavender, Limonene, Orange, Cinnamon, Peppermint, Spearmint, Hyssop, Thyme, Lemongrass, Sage, Pine, Lemon, Eucalyptus, Citrus, and Citronella.

11. The method of claim 9, wherein the composition is applied by spraying, fogging or treating with aerosol.

12. The method of claim 9, wherein the bed bugs are Cimex lectularius, Cimex hemipiterus or both or wherein the pest is an Arthropod selected from the group consisting of Chelicerata, and Tracheata or wherein the pest is a spider, ant, termite, roach, scorpion, flea, bed bug, fly, tick, lice or mite, wherein the composition controls or kills the one or more pests, bed bugs, insects, a pest infestation or any combinations thereof by an ovicidal action, a growth regulation, an anti-feedant action, a knockdown, a contact kill, a repellent action or any combinations thereof.

13. The method of claim 9, further comprising the optional steps of:
exposing the target area to about 30° to 33° C. for 5 days after applying the pest control composition;
inspecting the target area for signs of hatched pests 5 to 10 days after applying the pest control composition; and
reapplying the pest control composition if signs of hatched pests are observed.

14. A method for controlling one or more pests, bed bugs, insects, a pest infestation or any combinations thereof in a target area comprising:
identifying a target area suspected of having the pests, bed bugs, insects, a pest infestation or any combinations thereof;
treating the target area by applying an effective amount of pest control composition effective to control or kill the pests, the insects or a combination to the target area, wherein the pest control composition comprises a Cedarwood oil and a Siloxane;
monitoring the effectiveness of the treatment by one or more methods at a regular or pre-determined time interval.

15. The method of claim 14, wherein the pest control composition further comprises one or more essential oils selected from the group consisting of Rosemary, Geranium, Rose, Clove, Lavender, Limonene, Orange, Cinnamon, Peppermint, Spearmint, Hyssop, Thyme, Lemongrass, Sage, Pine, Lemon, Eucalyptus, Citrus, and Citronella.

16. The method of claim 14, wherein the bed bugs are Cimex lectularius, Cimex hemipiterus or both or wherein the pest is an Arthropod selected from the group consisting of Chelicerata, and Tracheata or wherein the pest is a Myriapoda, Arachnida or Insecta or wherein the pest is a spider, ant, termite, roach, scorpion, flea, bed bug, fly, tick, lice or mite.

17. The method of claim 14, wherein the composition controls or kills the one or more pests, bed bugs, insects, a pest infestation or any combinations thereof by an ovicidal action, a growth regulation, an anti-feedant action, a knockdown, a contact kill, a repellent action or any combinations thereof.

18. An insecticide composition comprising Cedarwood oil and Siloxane.

19. A method for controlling one or more pests comprising the steps of:
applying an amount of pest control composition effective to control pests to a target area wherein the pest control composition comprises a Neem oil, wherein the Neem oil comprises 3000 ppm Azadirachtin, Salannin, Meliantriol, and Nimbin;
a masking agent selected from the group consisting of a carrier comprising Siloxane; and
an essential oil.

20. The method of claim 19, wherein the essential oil is Cedarwood oil.

21. The method of claim 14, further comprising the optional steps of:
exposing the target area to about 30° to 33° C. for 5 days after applying the pest control composition;
inspecting the target area for signs of hatched pests 5 to 10 days after applying the pest control composition; and
reapplying the pest control composition if signs of hatched pests are observed.
